(19) United States
(12) Patent Application Publication
(10) Pub. No.: US 2019/0161991 A1
(43) Pub. Date: May 30, 2019

(54) CONNECTING ELEMENT FOR CONNECTING TOWER PORTIONS, TOWER PORTION, TOWER, WIND TURBINE, AND METHOD FOR PRODUCING A TOWER PORTION AND FOR CONNECTING TOWER PORTIONS

(71) Applicant: Wobben Properties GmbH, Aurich (DE)

(72) Inventors: Samer MTAUWEG, Bremerhaven (DE); Bernd BOETTCHER, Aurich (DE); Markus LONGERU, Stade (DE)

(21) Appl. No.: 16/321,392

(22) PCT Filed: Jul. 25, 2017
(86) PCT No.: PCT/EP2017/068764

§ 371 Date: Jan. 28, 2019

(30) Foreign Application Priority Data
Jul. 29, 2016 (DE) 10 2016 114 114.3

(51) Int. Cl. E04H 12/08; F03D 13/20

(52) U.S. Cl. CPC E04H 12/085; F05B 2240/912; F05B 2230/604; F03D 13/20

(57) ABSTRACT

A connecting element for connecting tower portions of a wind turbine, to a tower portion, to a tower and to a wind turbine and also to a method for producing a tower portion and to a method for connecting tower portions. The connecting element comprises a fastening surface which has the form of a segment of a circumferential surface of the tower and is designed to be arranged on a circumferential surface of a tower portion, and also comprises a connecting surface which is arranged at an angle to the fastening surface and which has receptacles for receiving fastening elements.

### BACKGROUND

### Technical Field

The invention relates to a connecting element for connecting tower portions of a tower of a wind turbine. The invention further relates to a tower portion of a tower of a wind turbine, to a part of a tower of a wind turbine, to a tower of a wind turbine and to a wind turbine. The invention further relates to a method for producing a tower portion of a tower of a wind turbine and also to a method for connecting tower portions of a tower of a wind turbine.

### Description of the Related Art

Tower portions of a tower, in particular a steel tower, of a wind turbine are customarily connected to one another by connection flanges. Such connection flanges for attachment to one end of a tower portion are known, for example, from DE 101 26 049 A1 or DE 103 25 032 B3. However, the production and the transportation of annular connection flanges is complicated and expensive, in particular for large diameters as can be found specifically at the lower end of towers of large height. Furthermore, an improvement in the reliability and/or the load-bearing capacity of the connection is also desirable. The German Patent and Trademark Office has searched the following prior art in the priority application pertaining to the present application: DE 10 2010 025 840 A1.

### BRIEF SUMMARY

Provided is a connecting element for connecting tower portions, a tower portion, a part of a tower, a tower and a wind turbine and also a method for producing a tower portion and a method for connecting tower portions which reduce or eliminate one or more disadvantages of the existing solutions. Provided is a connecting element for connecting tower portions, a tower portion, a part of a tower, a tower and a wind turbine and also a method for producing a tower portion and a method for connecting tower portions which improve the reliability and/or the load-bearing capacity of the connection of tower portions.

According to a first aspect of the invention, provided is a connecting element for connecting tower portions of a tower of a wind turbine, comprising a fastening surface which has the form of a segment of a circumferential surface of the tower and is designed to be arranged on a circumferential surface of a tower portion, and also comprises a connecting surface which is arranged at an angle to the fastening surface and which has receptacles for receiving fastening elements.

The connecting element according has a fastening surface which can be arranged on a circumferential surface of a tower portion, in particular of a steel tower. Furthermore, the connecting element has a form which corresponds to a segment of a circumferential surface of the tower. The fastening surface thus preferably substantially corresponds to the geometry of a part of the circumferential surface of the tower portion. If the tower portion is substantially tubular and/or hollow-cylindrical, the fastening surface thus preferably has the form of a lateral segment of a cylinder. If the tower portion is substantially frustoconical, the fastening surface thus preferably has the form of a lateral segment of a cone, in particular of a truncated cone. If the tower portion is polygonal, the fastening surface thus preferably has a planar a real extent which corresponds to a circumferential surface of one of the sides of the polygonal tower portion.

The form of the fastening surface as a segment of a circumferential surface of the tower refers in particular to a segment in the circumferential direction of the tower, which means in particular that the fastening surface of an individual connecting element does not form a ring, in particular a circular ring or polygon, but rather covers the circumferential surface of a tower portion only over a part of its circumference.

The fastening surface can be designed to be planar, in particular not curved, or can have a radius, wherein this radius also preferably corresponds to the radius of the circumferential surface of the tower portion or is slightly smaller than this radius. Particularly if the fastening surface has the form of a lateral segment of a cone, this radius can vary in a vertical direction in the installed state, in particular taper upwardly.

In the installed state and in the operating state, towers of wind turbines generally have a vertical longitudinal axis and an annular cross section orthogonally to this longitudinal axis. This annular cross section can be circular or ring-shaped or else have a polygonal shape. In this application, the term “annular” is therefore to be understood as meaning not only a circular ring-shaped configuration but also a polygonal and/or multi-corner configuration with a plurality of straight portions.

Insofar as reference is made here to the tower portion and the connecting element in relation to the tower portion, this refers in particular to the installed state of the connecting element in which the connecting element is arranged on the circumferential surface of the tower portion. In particular, statements relating to direction, such as, for example, radial, tangential, in the circumferential direction, etc., preferably refer to a tower, in particular to a substantially vertical longitudinal axis of a tower, and refer to any cross-sectional shapes of such a tower, in particular both to circular-shaped cross sections and to polygonal cross sections. Preferably furthermore, statements such as horizontal, vertical, downward, upward, etc., also likewise refer to the installed state of a connecting element on a tower portion in a tower of a wind turbine.

A tower portion is understood here as an annular element which can have a circular ring-shaped or a polygonal cross section. A tower portion with a circular ring-shaped cross section can, for example, have the outer shape of a cylinder or a truncated cone (in particular in the case of tapering towers).

A tower comprises a plurality of tower portions which are arranged vertically above one another in the installed state and in the operating state of the wind turbine. What is to be understood as installed state here is in particular a state which relates to the vertically oriented tower which—insofar as a correspondingly operationally ready nacelle with rotor is arranged on the tower—also corresponds to the operating state of the wind turbine. A substantially horizontal orientation of the longitudinal axis, for example in the case of manufacture and/or transportation of the tower or parts thereof, is not meant here by installed state. The orientations described for the installed state are to be correspondingly adapted in the manufacturing and/or transportation state to the temporarily nonvertically oriented longitudinal axis of the tower or of a part thereof.

Towers of wind turbines generally taper from their lower end to their upper end. The orientation of the tower wall of a tapering tower generally deviates only by a few degrees from the vertical. If reference is made in this application to orientations, in particular in the installed state, such as, for example, upward, downward, radial, horizontal, vertical, etc., this should therefore correspondingly also apply to tapering towers and, accordingly, tower walls which are inclined slightly with respect to the vertical.

Various modes of construction for towers of wind turbines are known, in particular, towers with a solid mode of construction, consisting of concrete and/or reinforced concrete and/or prestressed concrete and/or steel, have become prevalent. The invention present here relates in particular to towers with a steel mode of construction or to parts of towers with a steel mode of construction in which the connecting elements can be fastened, in particular welded, to tower portions made of steel. However, connecting elements can also be fastened to tower portions made of concrete and/or reinforced concrete and/or prestressed concrete, for example by parts of the connecting elements being concreted in.

The fastening surface serves in particular to mount or to fasten the connecting element to a tower portion. In particular, a substantially linear fastening can also take place for this purpose, in particular at an upper and/or lower edge of the fastening surface in the installed state of the connecting element.

In addition to the fastening surface, the connecting element has a connecting surface which is arranged at an angle to the fastening surface. The arrangement of the fastening surface and the connecting surface at an angle to one another means in particular that the two surfaces do not lie in the same plane. In the case of a connecting element whose fastening surface has the form of a lateral segment of a cylinder or is of planar design, the connecting surface can preferably be oriented orthogonally to the fastening surface. In the case of a connecting element which is provided for a tapering tower portion and whose fastening surface has for example the form of a lateral segment of a cone or is of planar design, the connecting surface can preferably also be oriented with respect to the fastening surface at an angle which differs from 90°, for example at an angle of 60° to 90°.

The receptacles which are arranged in the connecting surface serve for receiving fastening elements. In particular, it is preferred that the receptacles are arranged and designed to receive fastening elements which are arranged in receptacles of a connecting surface of a further connecting element which is arranged on a further tower portion.

A particular advantage of the connecting element is that the formation of an annular, in particular circular ring-shaped, flange can be dispensed with. The extent of a connecting element in the circumferential direction of a tower portion preferably corresponds to less than 360 degrees, in particular less than 180 degrees, preferably less than 90 degrees. In particular, an extent of the connecting element in the circumferential direction of a tower portion of less than 60 degrees, in particular less than 45 degrees, for example less than 30 degrees, can be preferred.

Such individual connecting elements can be produced and/or transported in a significantly more cost-effective manner than annular, in particular circular ring-shaped, connection flanges. Furthermore, such individual connecting elements can also be connected to tower portions in a more cost-effective manner and/or with greater reliability. For example, an integrally bonded connection, for instance by means of welding, of connecting elements to a tower portion can preferably occur under secured production conditions even before transporting the tower portion to the construction site at which the tower is to be erected.

Furthermore, connecting elements can be produced in this way that have a greater extent in the axial and/or radial direction than would be possible economically and/or for production and/or transportation reasons than in the case of a corresponding annular, in particular circular ring-shaped, connection flange. In this way, a higher load-bearing capacity of a connection produced by such connecting elements can be achieved.

The fastening surface can have the form of a segment of an inner circumferential surface of the tower and be designed to be arranged on an inner circumferential surface of a tower portion. In this configuration, the connecting elements are preferably not visible on the outer circumferential surface of the tower. Furthermore, the arrangement of individual connecting elements allows a greater flexibility in terms of the interior configuration in the tower. For example, certain segments of the tower inner surface can be kept free for internal fittings, such as, for example, lines, climbing aids or the like.

The fastening surface can also have the form of a segment of an outer circumferential surface of the tower and be designed to be arranged on an outer circumferential surface of a tower portion.

A combination of connecting elements on the inner circumferential surface and on the outer circumferential surface can also be preferred, for example in order to replace a T-flange.

In a preferred refinement, there is provision that the connecting element has, in a tangential direction and/or along its main direction of extent, an extent which corresponds to a circular ring segment. The main direction of extent of the connecting element preferably lies in a tangential direction. In particular, it is preferred that not only the fastening surface has the form of a lateral segment of a cylinder or cone, but the connecting element corresponds overall only to a circular ring segment, that is to say is not circular ring-shaped.

According to a preferred embodiment, there is provision that the connecting element has, in a tangential direction and/or along its main direction of extent, an extent which corresponds to a segment of a polygon. The main direction of extent of the connecting element preferably lies in or parallel to the direction of one of the polygon sides, which can also be referred to here as tangential direction. In particular, it is preferred that not only the fastening surface has the form of a segment of a polygon, but the connecting element corresponds overall only to a segment, that is to say is not annular within the sense of a polygon.

According to a preferred embodiment, there is provision that the receptacles take the form of through-holes and/or blind holes. The receptacles can all take the form of through-holes or all take the form of blind holes. The receptacles can also partially take the form of through-holes and partially take the form of blind holes. The receptacles can preferably take the form of bores, in particular threaded bores, and/or threaded holes and preferably have an internal thread. Further preferably, the receptacles are arranged and designed to receive fastening elements with an external thread, in particular screws, threaded bolts or the like.

It is furthermore preferred that the receptacles are arranged in a row. A preferred development is distinguished by the fact that the receptacles are arranged in two, three or more rows. In particular, it is preferred that the two, three or more rows are spaced apart from one another in the radial direction.

The provision of a plurality of rows of receptacles, in particular if these are spaced apart from one another in the radial direction, can significantly increase the load-bearing capacity of a connection produced with the connecting elements. As compared with annular, in particular circular ring-shaped, connection flanges, a radial enlargement of the connecting elements is significantly simpler economically and/or for production- and/or transportation-related reasons. In the case of a connecting element, it is thus easier or possible in the first place and/or economically expedient to provide two or even more rows of receptacles which are spaced apart in the radial direction—and thus a correspondingly higher number of fastening elements. Particularly on account of the resultant increase of the lever, the load-bearing capacity of the connections which are produced with such connecting elements can be significantly increased. Furthermore, the connecting elements can be manufactured more easily with a higher tolerance than annular, in particular circular ring-shaped, connection flanges. The spacing apart of the connecting elements in the tangential direction and/or in the circumferential direction on the tower portion also makes it possible to obtain advantages in terms of the required dimensional stability, in particular in this direction. Even in the case of tower portions which are divided in the vertical direction, the provision of individual connecting elements has advantages since in this way it is not at first necessary for an annular, in particular circular ring-shaped, connection flange to be produced in a complicated manner in order then to be divided.

Furthermore, there is preferably provision that the row(s) is or are oriented rectilinearly or tangentially. A tangential or rectilinear orientation of the row(s) preferably corresponds to an arrangement of the row(s) coaxially or parallel to the fastening surface. The arrangement of a row in rectilinear form corresponds in particular to the orientation of a row as the shortest connection between its two end points.

In particular, there is provision that the receptacles of a row are arranged equidistantly and/or are spaced apart from one another at uniform spacings. The receptacles of a row are preferably spaced apart from one another in the tangential direction. The receptacles of different rows are preferably spaced apart from one another in the radial direction.

A further preferred development is characterized by a front surface which is preferably arranged substantially opposite to the fastening surface, and/or by a counter-surface which is preferably arranged substantially opposite to the connecting surface. The connecting surface is preferably connected to the fastening surface and to the front surface. Further preferably, the counter-surface is connected to the fastening surface and to the front surface.

A further preferred refinement comprises two lateral surfaces which are preferably substantially opposite to one another and/or are preferably arranged substantially radially and/or vertically in the installed state. The two lateral surfaces are each preferably connected to the fastening surface, the front surface, the connecting surface and the counter-surface.

It is furthermore preferred that the connecting surface and the counter-surface are arranged substantially parallel to one another. A preferred development is distinguished by the fact that, in the installed state, the connecting surface and/or the counter-surface are or is arranged substantially horizontally.

Furthermore, there is preferably provision that, in the installed state, a main direction of extent of the connecting surface and/or a main direction of extent of the counter-surface and/or a main direction of extent of the fastening surface and/or a main direction of extent of the front surface are or is arranged substantially tangentially.

According to a preferred embodiment, there is provision that the fastening surface and the front surface are arranged substantially coaxially to one another and/or the front surface is formed to be substantially rectilinear.

A rectilinear formation of the front surface is preferably provided in particular when the front surface is not curved.

It is furthermore preferred that, in the installed state, the fastening surface and/or the front surface are arranged substantially vertically. In the case of an upwardly tapering tower having tower portions in the form of a truncated cone, an orientation, which is arranged parallel to the cone lateral surface or coaxially to the tower portion, of the fastening surface and/or of the front surface in the installed state is also referred to here as substantially vertical.

With a design of the fastening surface in the form of a lateral segment of a cone, the radius of the fastening surface generally differs at the upper and lower end in the installed state. For example, the radius of the fastening surface at the transition of the fastening surface to the connecting surface can differ from the radius of the fastening surface at the transition of the fastening surface to the counter-surface. Which radius is the larger and which is the smaller depends in particular on the installed state and/or the direction in which the tower tapers.

A preferred development is distinguished by the fact that the fastening surface and/or the front surface and/or connecting surface and/or the counter-surface and/or the two lateral surfaces are or is not arranged in the same plane.

Furthermore, it is preferred that the fastening surface and/or the front surface and/or connecting surface and/or the counter-surface and/or the two lateral surfaces enclose or encloses a three-dimensional body. The main direction of extent of the body preferably lies in the tangential direction.

According to a further preferred embodiment, there is provision that the fastening surface and/or the front surface and/or the counter-surface and/or the two lateral surfaces are or is free of receptacles.

If they take the form of through-holes, the receptacles preferably extend from the connecting surface to the counter-surface. If the receptacles take the form of blind holes, the receptacles preferably terminate before the counter-surface, with the result that in this case the counter-surface is free of receptacles.

In a further preferred refinement, there is provision that the fastening surface has a greater tangential extent that the front surface and/or the connecting element has one or more lip extensions in the tangential direction. The greater tangential extent of the fastening surface is preferably not based or not based alone on the radial extent of the connecting element and a correspondingly smaller tangential extent of the front surface. Rather, tangential lip extensions are provided preferably adjoining the fastening surface in the radial direction, preferably on both tangential ends and/or lateral surfaces of the connecting element. As a result, the interspace in the circumferential direction between adjacent connecting elements can be reduced or eliminated. This can advantageously reduce the requirements placed on the thickness of the tower portion in this region and/or improve the load-bearing capacity of the tower portion in this region.

The receptacles extend, in the installed state, preferably in a substantially vertical direction from the connecting surface into the three-dimensional body.

Furthermore preferably, the receptacles preferably extend parallel to the fastening surface and/or to the front surface and/or to the lateral surfaces. It is furthermore preferred that the receptacles extend preferably orthogonally to the connecting surface and/or to the counter-surface.

According to a further aspect of the invention, provided is a tower portion of a tower of a wind turbine, comprising two, three or more above-described connecting elements which are arranged on a circumferential surface of the tower portion.

The connecting elements are preferably arranged on one or both axial ends of the tower portion. Furthermore preferably, the connecting elements are arranged on the circumferential surface of the tower portion in such a way that the connecting surfaces of the connecting elements point outwardly and/or inwardly in the axial direction.

A preferred refinement of the tower portion makes provision that the connecting elements are spaced apart from one another, preferably equidistantly, in the circumferential direction and/or in the tangential direction.

Individual or all connecting elements of a tower portion can also be offset in the axial direction to an axial end of the tower portion, in particular upwardly or downwardly in the axial direction with respect to a vertical orientation of the tower portion. The connecting elements of an axially adjoining end of an adjacent tower portion are preferably offset in the opposite axial direction. In this way, the connecting elements can simplify the positioning and/or centering of the tower portions with respect to one another, for example during mounting.

A further preferred refinement of the tower portion makes provision that the connecting elements are integrally bonded, in particular welded, to the inner surface of the tower portion. The connection preferably takes place under secured production conditions, for example by means of a welding robot. A welded connection of the connecting elements to the circumferential surface of the tower portion can take place, for example, by means of butt seams and/or fillet seams and/or (double) HV-seams and/or J-seams. The connecting elements are preferably connected to the tower portions at an upper edge of the fastening surface in the installed state, and/or at a lower edge of the fastening surface in the installed state.

According to a further aspect of the invention, provided is a part of a tower of a wind turbine, comprising two above-described tower portions which are connected to one another via fastening means which are arranged in the receptacles of the two tower portions.

The two tower portions are preferably arranged coaxially one above the other. Furthermore preferably, the two tower portions having the connecting elements arranged thereon are oriented in such a way that the receptacles of connecting elements, which are arranged above one another, of the two tower portions are in each case coaxially oriented, with the result that a fastening element can be received in a receptacle of a connecting element of the lower tower portion and in a receptacle of a connecting element of the upper tower portion and/or can pass through these receptacles of the upper and lower connecting element.

A further preferred refinement of the part of a tower makes provision that the fastening means take the form of screws and/or threaded bolts.

According to a further aspect of the invention, provided is a tower of a wind turbine, comprising at least one above-described part of a tower, and/or at least one above-described tower portion, and/or at least one above-described connecting element.

According to a further aspect of the invention, provided is a wind turbine, comprising at least one above-described tower, and/or at least one above-described part of a tower, and/or at least one above-described tower portion, and/or at least one above-described connecting element.

According to a further aspect of the invention, provided is a method for producing a tower portion of a tower of a wind turbine, comprising providing a tower portion, and arranging an above-described connecting element on a circumferential surface of the tower portion.

The method for producing a tower portion of a tower of a wind turbine can preferably be developed by preferably transporting the tower portion from a first assembly site to a second assembly site, and connecting the tower portion to a further tower portion which preferably has a greater axial extent.

In this refinement, a tower portion having a small axial extent, for example of less than 5 m, in particular less than 2 m, preferably of less than 1 m, is first provided with connecting elements. This preferably takes place at a first assembly site which can for example be particularly designed for the mounting of individual connecting elements which are distributed over a circumferential surface. This tower portion having the connecting elements arranged thereon can then be transported, for example, to a second assembly site, where this tower portion is then connected to a further tower portion. The further tower portion preferably has a greater axial extent, in particular an axial extent which corresponds to a multiple of the tower portion having the connecting elements arranged thereon. This method thus makes it possible first to connect the connecting elements to a tower portion and then to transport such a—preferably short—tower portion in order to connect to it to a—significantly longer—tower portion. The transportation of such a short tower portion having connecting elements is significantly easier than that of the long, further tower portion. The mounting of the individual connecting elements on a tower portion is also significantly easier in a short tower portion. The connection of the short tower portion having connecting elements to the long, further tower portion preferably takes place by welding and/or further preferably along the entire circumferential surface of the tower portions.

According to a further aspect of the invention, provided is a method for connecting tower portions of a tower of a wind turbine, comprising arranging two above-described tower portions one above the other, and connecting the two tower portions by arranging fastening elements in the receptacles of the connecting elements of the two tower portions. The tower portions are in particular arranged one above the other in such a way that, in the operating state of the wind turbine, they are arranged vertically one above the other. During production and/or during transportation, this can likewise correspond to an arrangement in the vertical direction, for example during offshore transportation of offshore towers, but also to an arrangement in the substantially horizontal direction if the towers or tower portions are transported in a lying or inclined manner.

The devices and methods of these further aspects of the invention preferably have features or method steps which make them particularly suitable for being used with a connecting element according to the invention and with developments of said element. Regarding the advantages, embodiment variants and embodiment details of these further aspects of the invention and their possible developments, reference is also made to the preceding description of the corresponding features of the connecting element and its possible developments.

### BRIEF DESCRIPTION OF THE SEVERAL VIEWS OF THE DRAWINGS

A preferred embodiment of the invention is described by way of example with reference to the appended figures, in which:

FIG. 1 shows a three-dimensional view of a wind turbine having a tower and a nacelle;

FIG. 2 shows a three-dimensional view of a third of a longitudinally divided tower portion having four connecting elements;

FIG. 3 shows a three-dimensional view of a part of a tower having two tower portions which are not yet connected;

FIG. 4 shows the part of a tower as per FIG. 3 in which the upper tower portion, the connecting elements and the fastening elements are in each case illustrated only by way of their edges;

FIG. 5 shows a three-dimensional view of three connecting elements, in particular of a lower tower portion;

FIG. 6 shows a three-dimensional view of three connecting elements, in particular of an upper tower portion;

FIG. 7 shows a three-dimensional view of a further embodiment of a connecting element; and

FIG. 8 shows a three-dimensional view of a further embodiment of connecting elements.

### DETAILED DESCRIPTION

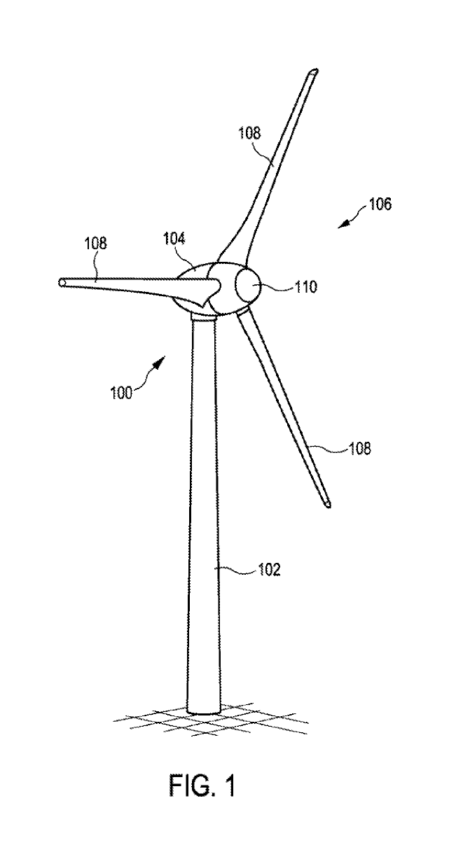

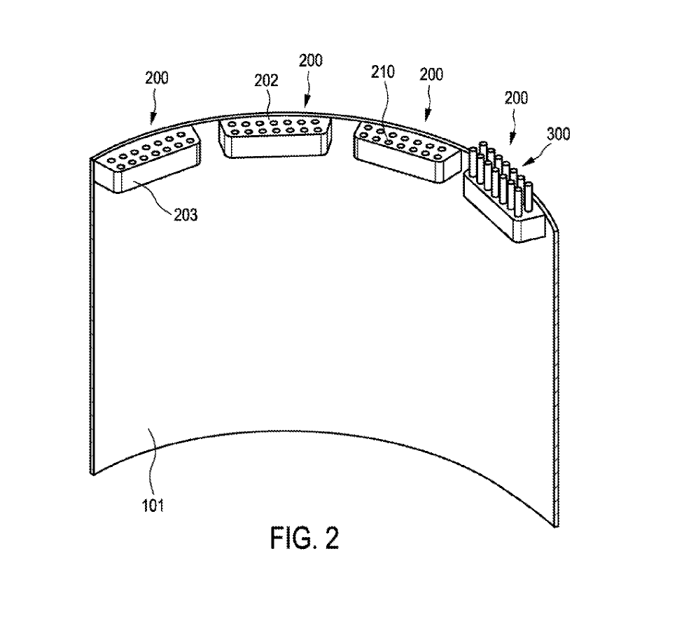

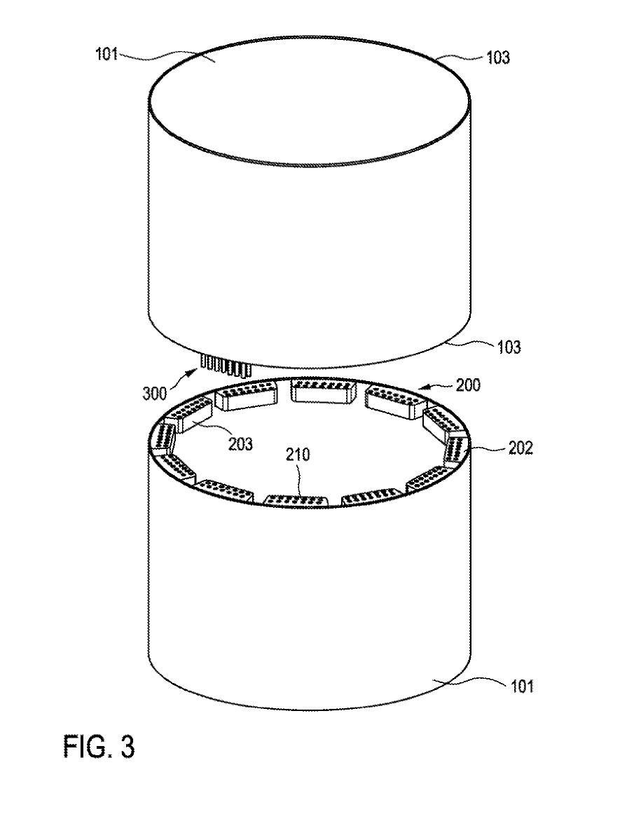

FIG. 1 shows a wind turbine 100 having a tower 102 and a nacelle 104. A rotor 106 having three rotor blades 108 and a spinner 110 is arranged on the nacelle 104. In operation, the rotor 106 is set into a rotational movement by the wind and thereby drives a generator in the nacelle 104. The tower 102 has two or more tower portions 101 which are illustrated in FIGS. 2 and 3.

FIG. 2 shows a three-dimensional view of a third (120°) of a longitudinally divided tower portion 101 for a tower 102 of a wind turbine 100 having four connecting elements 200. In one of the connecting elements 200, fastening elements 300 are arranged in the receptacles 210.

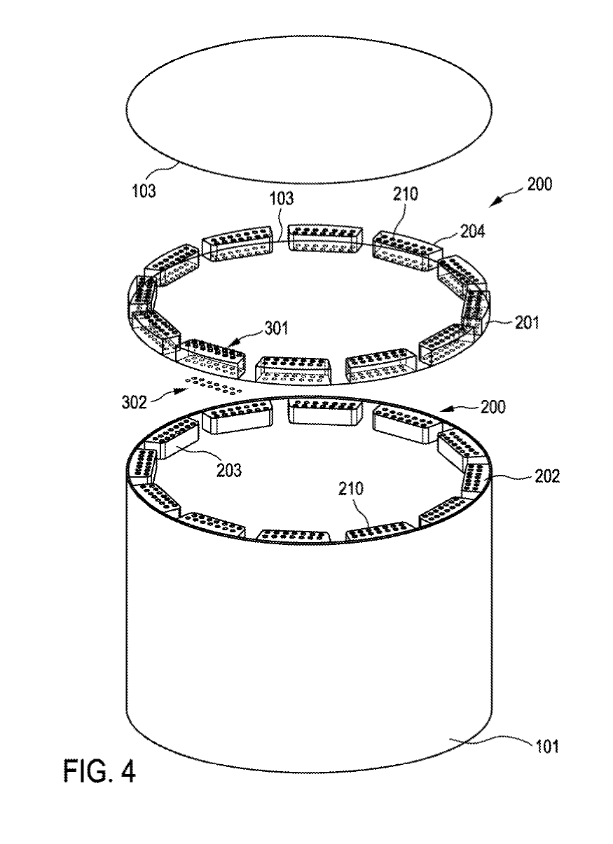

FIGS. 3 and 4 show a part of a tower having two coaxial tower portions 101 which are arranged vertically one above the other. In FIG. 4, the upper tower portion 101, the connecting elements 200 and the fastening elements 300 are illustrated only by way of their edges. In particular, the rings 103 mark the upper and lower axial end of the upper tower portion 101. The upper and lower ends of the fastening elements 300 are designated by 301 and 302.

The two tower portions 101 each have twelve connecting elements 200 which are spaced apart from one another in the tangential direction and/or in the circumferential direction and are arranged equidistantly. The connecting elements 200 have an extent in the circumferential direction of the tower portion 101 of less than 30 degrees.

On the lower tower portion 101, the connecting elements 200 are arranged on an upper axial end. On the upper tower portion 101, the connecting elements 200 are arranged on a lower axial end.

The two tower portions 101 are oriented with respect to one another in such a way that the fastening elements 300—illustrated here only for one connecting element 200—can engage in the receptacles of the respective connecting element situated axially therebelow.

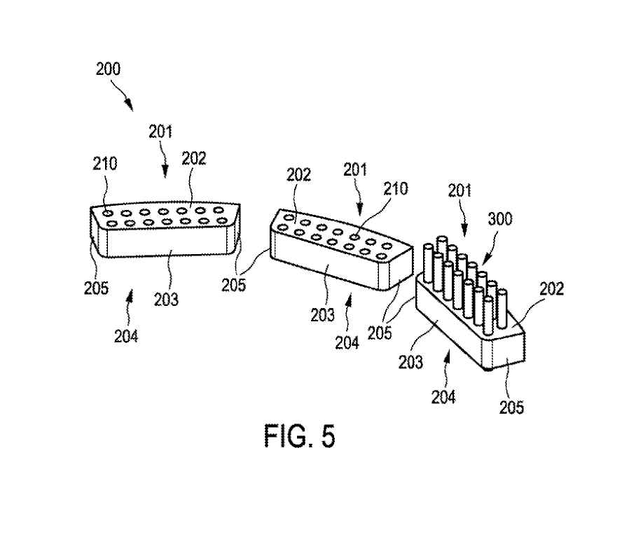

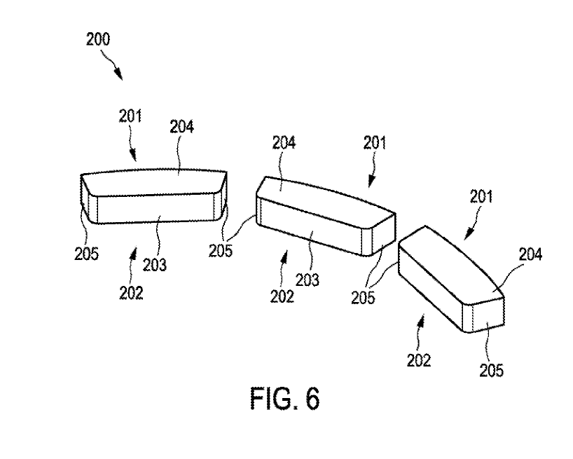

FIGS. 5 and 6 illustrate in more detail the connecting elements of the lower and upper tower portion 101. Fastening elements 300 are illustrated only for one connecting element 200, but are preferably situated in the receptacles of all connecting elements 200. Fastening elements 300 are preferably arranged and designed in such a way that they can interconnect two connecting elements arranged vertically one above the other.

Each of the connecting elements 200 has a fastening surface 201 which has the form of a segment of an inner circumferential surface of the tower, in the exemplary embodiment shown here the form of a lateral segment of a cylinder. The fastening surface is designed to be arranged on the inner surface of a tower portion 101. It is correspondingly also possible to have connecting elements whose fastening surface has the form of a segment of an outer circumferential surface of the tower. In the case of an arrangement on an outer circumferential surface of the tower, a front surface situated opposite to the fastening surface would point outwardly.

Each of the connecting elements 200 further has a connecting surface 202 having receptacles 210, and a counter-surface 204 which is situated opposite to this connecting surface 202. The connecting surfaces 202 of the connecting elements 200 point outwardly in the axial direction.

The receptacles 210 can be through-holes or blind holes. In the case of the connecting elements 200 illustrated in FIG. 6, the receptacles take the form of blind holes since the counter-surface 204 does not exhibit any openings. In the case of the connecting elements 200 illustrated in FIG. 5, the receptacles 210 can take the form of through-holes or blind holes.

Each of the connecting elements 200 further has a front surface 203 which is situated substantially opposite to the fastening surface 201. In the case of the fastening elements 200 illustrated here, the front surfaces 203 are designed to be rectilinear, that is to say not curved, and parallel to the rectilinear orientation of the two rows of receptacles 210. Equally possible, for example, is also a tangential or coaxial orientation or curvature of the rows and/or front surfaces 203.

Each of the connecting elements 200 further has two lateral surfaces 205 which are situated substantially opposite to one another and are arranged both substantially radially and substantially vertically. The two lateral surfaces 205 are each connected to the fastening surface 201, the front surface 203, the connecting surface 202 and the counter-surface 204.

The lateral surfaces 205, the fastening surface 201 and the front surfaces 203 are free of receptacles.

The fastening surface 201, the front surface 203, the connecting surface 202, the counter-surface 204 and the lateral surfaces 205 are not arranged in the same plane and enclose a three-dimensional body. In the installed state illustrated here in the figures, the main direction of extent of this body lies, just as a main direction of extent of the fastening surface 201 and a main direction of extent of the front surface 203 and a main direction of extent of the connecting surface 202 and a main direction of extent of the counter-surface 204, in a substantially tangential direction. In addition to the surfaces which are oriented substantially vertically in the installed state, namely fastening surface 201, front surface 203 and lateral surfaces 205, the connecting surface 202 and the counter-surface 204 are oriented substantially horizontally in the installed state.

The receptacles 210 of the connecting elements 200 are arranged in two rows which are spaced apart from one another in the radial direction. The two rows are arranged rectilinearly, i.e., they are not arranged in the tangential direction and/or circumferential direction and are not arranged coaxially to the fastening surfaces 201. In the rectilinear arrangement of the rows which is shown here, the orientation of the rows corresponds only at their center point to a tangent to a fastening surface 201 and otherwise deviates from the tangential orientation. The arrangement of the rows in rectilinear form also corresponds to the orientation of the rows as the shortest connection between their respective end points, in particular of the respectively outer receptacles 210.

The receptacles 210 extend, in the installed state, in a substantially vertical direction from the connecting surface 202 into the three-dimensional body. The receptacles 210 also extend parallel to the fastening surface 201, to the front surface 203 and to the lateral surfaces 205. The receptacles 210 additionally extend orthogonally to the connecting surface 202 and to the counter-surface 204.

The connecting elements 200 are connected by this fastening surface 201 to the inner surfaces of the tower portions 101, preferably by an integral bond, in particular by a linear connection in the form of weld seams on the upper and lower edge of the fastening surfaces 201. At its upper and lower edges, the fastening surface 201 transitions into the connecting surface 202 and the counter-surface 204.

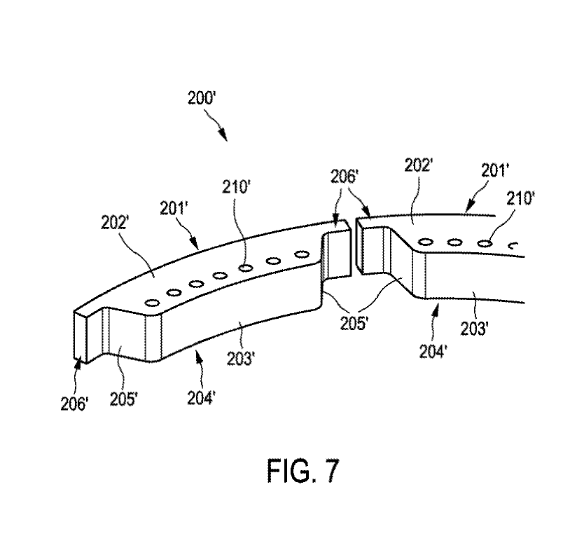

FIG. 7 shows a positive alternative embodiment of connecting elements 200′ which can be used in addition to or as an alternative to the connecting elements 200 illustrated in the remaining drawings. The connecting element 200′ has, similarly to a connecting element 200, a fastening surface 201′, a front surface 203′, a connecting surface 202′, a counter-surface 204′ and lateral surfaces 205′. The fastening surface 201′ has a greater tangential extent than the front surface 203′. This is particularly caused by the fact that the connecting element 200′ has two lip extensions 206′ which can serve for stabilizing the tower portion in the regions between 2 connecting elements and can reduce the requirements placed on the ceiling of the tower portion in this region.

As an alternative to the design illustrated here in the figures in which the tower portions are designed to be hollow-cylindrical and the fastening surfaces 201 have the form of a lateral segment of a cylinder, the fastening surfaces 201 can also have the form of a lateral segment of a cone in order to be arranged on the inner surfaces of tower portions in the form of a truncated cone. Furthermore, the tower portions can be of polygonal design and the fastening surfaces can be designed to be planar, without curvature.

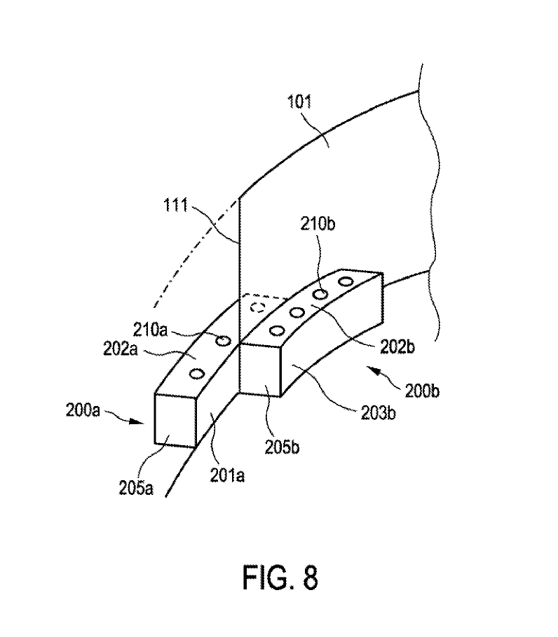

A further possible embodiment is illustrated in FIG. 8, in which a connecting element 200a is arranged on an outer circumferential surface of the tower portion 101, and a connecting element 200b is arranged on an inner circumferential surface of the tower portion 101. The fastening surface 201a of the connecting element 200a has the form of a circular ring segment and is arranged on the outer circumferential surface of the tower portion 101. In the case of the connecting element 200a, a front surface situated opposite to the fastening surface 201a points outwardly. The fastening surface 201b of the connecting element 200b likewise has the form of a circular ring segment, but is arranged on the inner circumferential surface of the tower portion 101. The front surface 203b of the connecting element 200b points inwardly.

The connecting surfaces 202a, 202b of the two connecting elements 200a, 200b point substantially upwardly and have receptacles 210a, 210b. The lateral surfaces 205a, 205b are oriented tangentially.

It is also clear from the example shown in FIG. 8 that the tower portion 101 is composed of a plurality of parts which are assembled at a substantially vertical joint 111. As shown in FIG. 8 by the example of the connecting element 200a, it can be very preferable that one or more connecting elements are arranged in such a way that they overlap such a vertical joint of the tower portion.

The connecting elements and tower portions connected therewith and also a tower having such tower portions have various advantages. In particular, such individual connecting elements can be produced and transported in a significantly more cost-effective manner than circular ring-shaped connection flanges. Furthermore, the radial and axial extent of the connecting elements can be increased in a significantly simpler manner than in the case of a circular ring-shaped connection flange, with the result that the arrangement of two rows of receptacles and hence also of two rows of fastening elements becomes possible and thus the reliability and load-bearing capacity of the connection can be improved. A greater radial extent of the connecting pieces leads in particular to a better span length of the connections. Furthermore, the arrangement of individual connecting elements allows greater flexibility with respect to the interior configuration in the tower.

1. A connecting element for connecting tower portions of a tower of a wind turbine, comprising a fastening surface that is a segment of a circumferential surface of the tower and is designed to be arranged on a circumferential surface of a tower portion, and a connecting surface arranged at an angle to the fastening surface and has a plurality of receptacles for receiving fastening elements.

2. The connecting element as claimed in claim 1, wherein the fastening surface has a shape of a segment of a circumferential surface of the tower and is designed to be arranged on at least one of: an inner circumferential surface of the tower portion or an outer circumferential surface of the tower portion.

3. The connecting element as claimed in claim 1, wherein:
the connecting element has a longitudinal direction that corresponds to a circular ring segment, and
the plurality of receptacles are through-holes or blind holes.

4. The connecting element as claimed in claim 1, wherein the plurality of receptacles are arranged in a row.

5. The connecting element as claimed in claim 1, comprising:
a front surface arranged substantially opposite to the fastening surface or the connecting surface; and
two lateral surfaces opposite to one another and arranged substantially radially and vertically.

6. The connecting element as claimed in claim 5, wherein at least one of:
in an installed state in which the connecting element is fastened to the tower portion at the fastening surface, the connecting surface and the front surface are arranged substantially parallel to one another,
in the installed state, the connecting surface is arranged substantially horizontally,
in the installed state, a longitudinal direction of the connecting surface, a longitudinal direction of the front surface, a longitudinal direction of the fastening surface are arranged substantially tangentially,
the fastening surface and the front surface are arranged substantially coaxially to one another; and
in the installed state, the fastening surface is arranged substantially vertically.

7. The connecting element as claimed in claim 5, wherein at least one of:
the fastening surface, the front surface connecting surface, and the two lateral surfaces are not arranged in the same plane as each other,
the fastening surface, the front surface, the connecting surface, and the two lateral surfaces enclose a three-dimensional body,
the fastening surface, the front surface, the two lateral surfaces do not include the plurality of receptacles,
the fastening surface has a larger tangential extent than the front surface, and
the connecting element has one or more lip extensions in the tangential direction.

8. A tower portion of a tower of a wind turbine, comprising a plurality of connecting elements as claimed in claim 1 that are arranged on a circumferential surface of the tower portion.

9. The tower portion as claimed in claim 1, wherein the plurality of connecting elements are spaced apart from one another in the circumferential direction.

10. A part of a tower of a wind turbine, comprising two tower portions as claimed in claim 9, wherein the two tower portions are connected to one another via fastening means which are arranged in the plurality of receptacles of the two tower portions.

11. A tower of a wind turbine, comprising a plurality of the parts of the tower of the wind turbine as claimed in claim 10.

12. A wind turbine, comprising:
the tower as claimed in claim 11; and
a nacelle arranged on the tower.

13. A method comprising:
forming a tower of a wind turbine, wherein forming comprises arranging a connecting element as claimed in claim 1 on a circumferential surface of a first tower portion.

14. The method as claimed in claim 13, comprising:
transporting the first tower portion from a first assembly site to a second assembly site; and
connecting the first tower portion to a second tower portion.

15. A method for connecting tower portions of a wind turbine, comprising:
arranging two tower portions as claimed in claim 7 one above the other,
connecting the two tower portions by arranging fastening elements in the plurality of receptacles of the connecting elements of the two tower portions.

16. The connecting element as claimed in claim 4, wherein the plurality of receptacles are arranged in two or more rows, wherein each row is spaced apart from an adjacent row in the radial direction.

17. The tower portion as claimed in claim 9 wherein the plurality of connecting elements are integrally bonded to the circumferential surface of the tower portion.
